(19) United States
(12) Patent Application Publication
(10) Pub. No.: US 2009/0187415 A1
(43) Pub. Date: Jul. 23, 2009

(54) METHOD AND SYSTEM FOR VALIDATING A SERVICE ORDER

(76) Inventors: ANDRE LABAHN, Uetersen (DE); Andreas Meider, Koeln (DE)

Correspondence Address: SAP AG, 3410 HILLVIEW AVENUE, PALO ALTO, CA, 94304, US

(21) Appl. No.: 12/212,652

(22) Filed: Sep. 18, 2008

Related U.S. Application Data
(60) Provisional application No. 61/022,816, filed on Jan. 22, 2008.

(51) Int. Cl. G06Q 99/00; G06Q 30/00

(52) U.S. Cl. 705/1

(57) ABSTRACT

Disclosed is a method and system for receiving a service order having a service order parameter and a service type of the service order and determining a set of services based on the service order parameter and the service type. A service validation rule set is fetched based on the service type, the set of services is evaluated with the service validation rule set to generate an evaluation result and a service order proposal matching the service order is generated based on the evaluation result.

This application claims the benefit of and priority to U.S. Provisional Patent Application No. US 61/022,816, filed Jan. 22, 2008, titled “METHOD AND SYSTEM FOR VALIDATING A SERVICE ORDER,” which is incorporated herein by reference in its entirety.

### FIELD OF THE INVENTION

The invention generally relates to the field of enterprise business software and specifically to service validation software for validating a service order.

### BACKGROUND OF THE INVENTION

Currently, service providers such as telecommunication companies, internet service providers and logistic service providers typically make an effort to provide the best service to their customers. But there are many challenges involved in providing a good, valuable and reliable service to a customer. The needs of one customer may not be the same as that of the other customer. Also, service products get more and more complex if the needs of the customer have to be met. The characteristics of the service such as speed of an internet connection, wireless capability, a number of channels provided in cable television and pricing often depend on various conditions such as available infrastructure, cost of the infrastructure, and market conditions. Thus, it becomes challenging for the service providers to provide a service that may satisfy every customer.

A service agent acting as a reseller of a service typically has a contract with service providers to sell a product of the service providers to the customer. The service agent typically obtains an incentive such as a financial incentive for selling the product of the service provider. The customer approaches the service agent with a service request. The service request contains details of various features preferred by the customer in the service. Typically, it is challenging for the service agent to find the service that best suits the service request of the customer since the service agent provides services from a number of service providers. The service agent typically checks the list of services manually and evaluates the list of services to find a service that matches the service request. After evaluating the list of services, the service agent proposes the service that suits the service request. In another scenario, the service agent may just propose the service to the customer based on prior experience. Manual evaluation of the list of services may be error prone, inefficient and time consuming, especially if the number of services is significantly large.

### SUMMARY OF THE INVENTION

What is described is a method and system for receiving a service order having a service order parameter and a service type of the service order and determining a set of services based on the service order parameter and the service type. A service validation rule set is fetched based on the service type, the set of services is evaluated with the service validation rule set to generate an evaluation result and a service order proposal matching the service order is generated based on the evaluation result.

### BRIEF DESCRIPTION OF THE DRAWINGS

FIG. 1 is a flow diagram for validating a service order and generating a service order proposal according to an embodiment of the invention.

FIG. 2 is a flow diagram for validating a service order by a service validation engine according to an embodiment of the invention.

FIG. 3 illustrates tables for an exemplary service order, a service validation rule set, set of services and service order proposals according to an embodiment of the invention.

FIG. 4 is a block diagram of a system to validate an exemplary service order according to an embodiment of the invention.

FIG. 5 is a block diagram of a system to validate a service order according to an embodiment of the invention.

### DETAILED DESCRIPTION

What is described is a method and system for receiving a service order having a service order parameter and a service type of the service order and determining a set of services based on the service order parameter and the service type. A service validation rule set is fetched based on the service type, the set of services is evaluated with the service validation rule set to generate an evaluation result and a service order proposal matching the service order is generated based on the evaluation result.

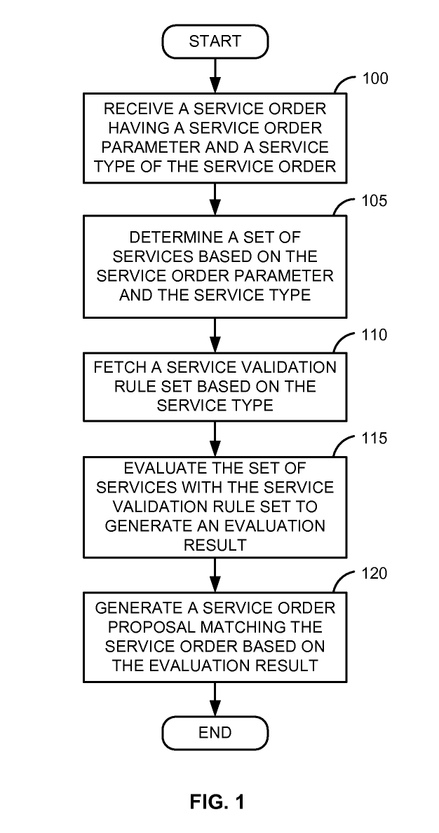

FIG. 1 is a flow diagram for validating a service order and generating a service order proposal according to an embodiment of the invention. At step 100, a service order is received. The service order includes a request for a service such as an internet service, courier service, cable television service, and telephone service. A service order parameter may include a service characteristic such as cost of the service, speed of the internet service, number of channels provides in cable television, a number of days within which a courier has to be delivered, and a delivery area. A service type may include a value such as courier service, cable television service, internet service and telephone service. In an embodiment, the service type may be a group of values such as “internet service, wireless service, 2 mega bits per second (mbps)”. At step 105, a set of services available or provided by a service provider is determined based on the service order parameter and the service type of the service order. The set of services may be fetched from a service repository based on the service order parameter and the service type.

At step 110, a service validation rule set is fetched from a database based on the service type. The service validation rule set has business rules defined for the service. At step 115, the set of services are evaluated with the service validation rule set by a service validation engine to determine the service that may match the service requested by the service order and an evaluation result is generated. At step 120, a service order proposal matching the service order is generated based on the evaluation result. In an embodiment, more than one service order proposal may be generated. The service order proposal has a rank that represents a degree of matching of the service order proposal with the service order.

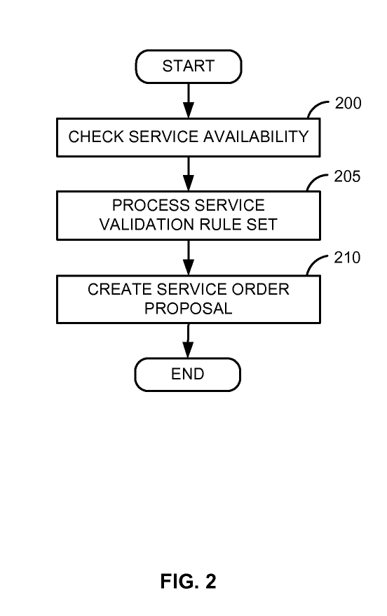

FIG. 2 is a flow diagram for validating a service order by a service validation engine according to an embodiment of the invention. At step 200, the service requested by the service order is checked for availability. The service provider may rely on a third party such as another organization, and another person to provide the service requested by the service order. For example, to provide an internet service, the internet service provider may have to rely on a third party such as a modem manufacturer to provide a modem that is necessary for providing the internet service. At step 205, the service validation rule set is processed by the service validation engine to determine a service order proposal that provides the service requested by the service order. At step 210, the service order proposal is created.

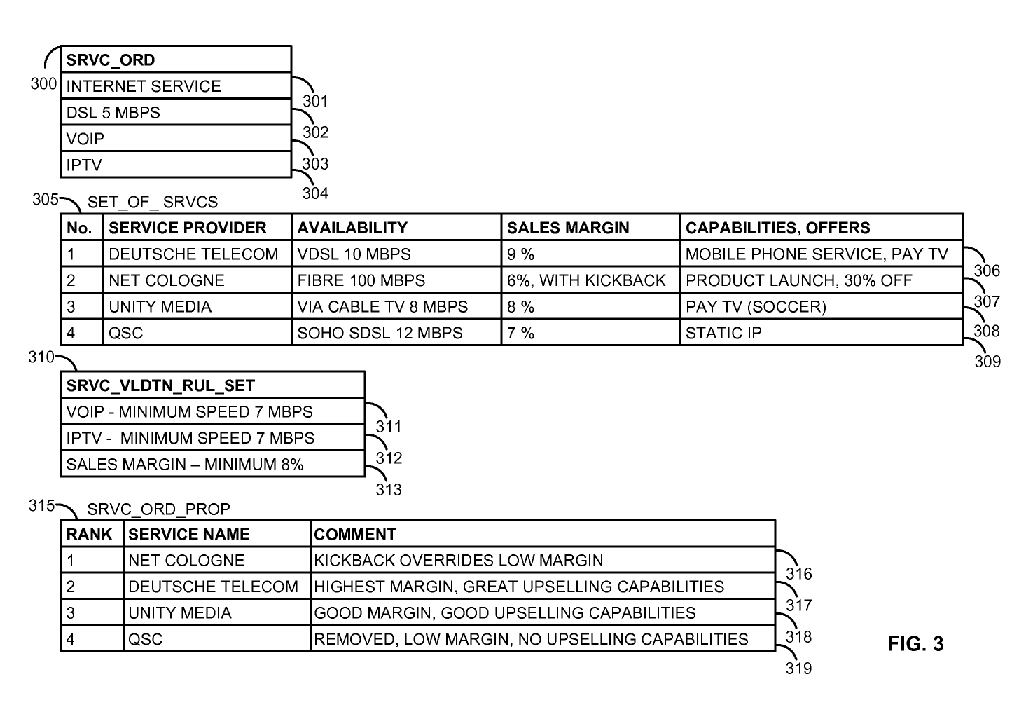

FIG. 3 illustrates tables for an exemplary service order, a service validation rule set, set of services and service order proposals according to an embodiment of the invention. Table srvc_ord 300 depicts a service order received for a digital subscriber line (DSL) internet service with a speed of 5 MBPS. The table srvc_ord 300 also indicates that the customer requires a voice over internet protocol (VOIP) service and an internet protocol television (IPTV) service. The service order has service type 301 with value “internet service” and service order parameters such as first service order parameter 302 with value “DSL 5 MBPS”, second service order parameter 303 with value “VOIP” and third service order parameter 304 with value “IPTV”.

Table set_of_srvcs 305 depicts a set of services retrieved from a service repository based on service type 301 and service order parameters such as first service order parameter 302, second service order parameter 303 and third service order parameter 304. The set of services include services such as first service 306, second service 307, third service 308, and fourth service 309 which are provided from various service providers. Each of the services has various characteristics as depicted in the table set_of_srvcs 305.

Table srvc_vldtn_rul_set 310 depicts a service validation rule set that is obtained from a database based on service type 301. The service validation rule set has business rules defined for a service. Any service which is proposed by a service agent has to comply with the business rules. The business rules, typically, ensure that a business is run in an efficient and profitable manner while considering requirements of the customer. The business rules ensure the following among others:
The service provided to the customer is of good quality;
The service is provided at an affordable price;
The service provided is easily scalable; and
The service agent also makes a profit by selling the service to the customer.

The table srvc_vldtn_rul_set 310 has business rules such as first business rule 311, second business rule 312 and third business rule 313. First business rule 311 states that a minimum speed of 7 MBPS is required for the VOIP service. Similarly, second business rule 312 states that a minimum speed of 7 MBPS is required for the IPTV service. Third business rule 313 states that a minimum of 8% sales margin is necessary for the service agent. In an embodiment, there may be a plurality of service validation rule sets.

Table srvc_ord_prop 315 depicts service order proposals generated based on an evaluation of the set of services depicted in the table set_of_srvcs 305 with the service validation rule set depicted in the table srvc_vldtn_rul_set 310. The table srvc_ord_prop 315 include proposals such as first service order proposal 316, second service order proposal 317, third service order proposal 318, and fourth service order proposal 319. Each of the service order proposals such as first service order proposal 316, second service order proposal 317, third service order proposal 318, and fourth service order proposal 319 has a rank that indicates a degree of matching of the service order proposal with service order. The rank is indicated as a column in the table srvc_ord_prop 315. The rank would assist the service agent in choosing a particular service order proposal from the table srvc_ord_prop 315 to and propose it to the customer.

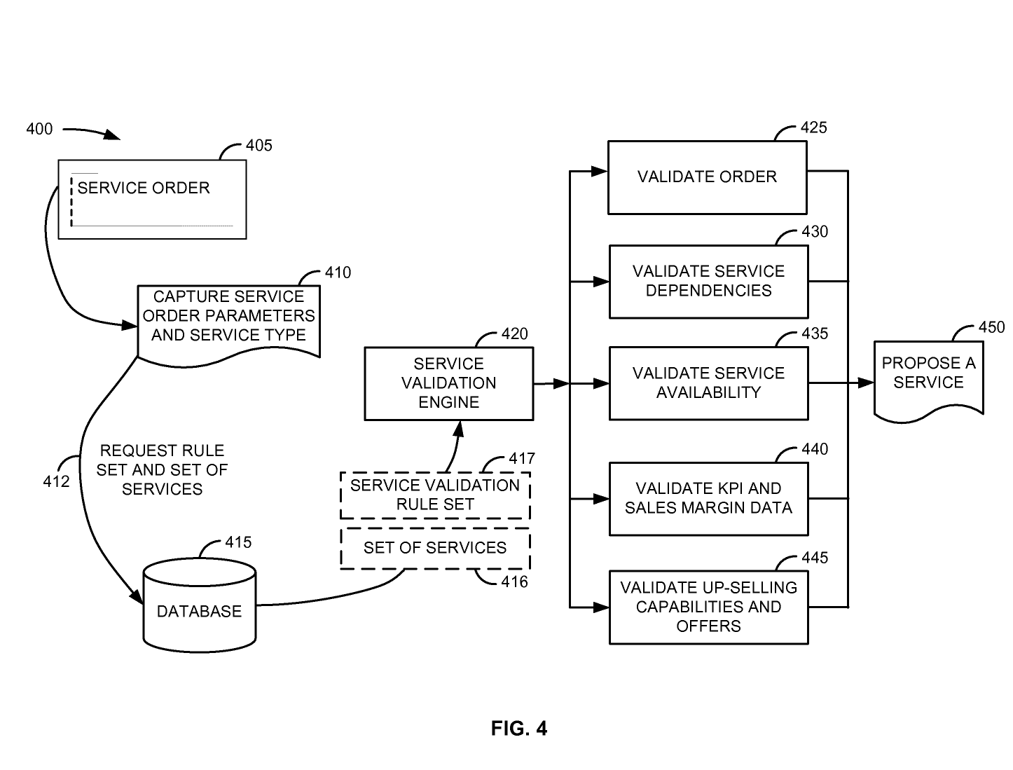

FIG. 4 is a block diagram of a system to validate an exemplary service order according to an embodiment of the invention. A service agent receives a request for an internet service as service order 405. At process block 410 a service type and service order parameters of service order 405 are captured in the table srvc_ord 300 (as shown in FIG. 3). After service type 301 and service order parameters such as first service order parameter 302, second service order parameter 303 and third service order parameter 304 are captured, system 400 executes a request for fetching a service validation rule set and a set of services.

System 400 includes database 415, and service validation engine 420. Set of services 416 and service validation rule set 417 are obtained from database 415. In an embodiment, database 415 may be connected to a service repository that contains services provided by various service providers. The service repository may be a third party service repository, that is, the service repository may belong to another service agent. Set of services 416 are fetched from database 415 based on service type 301 and service order parameters such as first service order parameter 302, second service order parameter 303 and third service order parameter 304. Set of services 416 that include first service 306, second service 307, third service 308, and fourth service 309 are captured in the table set_of_srvcs 305. Service validation rule set 417 is fetched from database 415 based on service type 301. Service validation rule set 417 is captured in the table srvc_vldtn_rul_set 310. Service validation rule set 417 includes business rules such as first business rule 311, second business rule 312 and third business rule 313 as depicted in the table srvc_vldtn_rul_set 310.

Service validation engine 420 evaluates set of services 416 with service validation rule set 417. Service validation engine ensures that set of services 416 are validated against all the business rules in service validation rule set 417. Service validation engine 420 validates a number of factors including but not limited to service order, service dependencies, service capability, up-selling capabilities and offers, key performance indicators (KPI) and sales margin data. In validate order 425 process block, service validation engine validates service order 405 for a feasibility of the service. For example, in service order 405 if first service order parameter 302 had value “DSL 0 MBPS”, instead of “DSL 5 MBPS” then service validation engine generates an error message “invalid service order” on validating service order 405.

At validate service dependencies 430 process block, service validation engine 420 validates a dependency of first service order parameter 302 with second service order parameter 303 and third service order parameter 302. Service validation engine 420 checks with service validation rule set 417 to see if there are any business rules that define the dependency between service order parameters. Service validation engine 420 finds out that first business rule 311 states that a minimum speed of 7 MBPS is necessary for VOIP service and second business rule 312 states that a minimum speed of 7 MBPS is necessary for IPTV service. Thus, service validation engine 420 determines that a service with a minimum speed of 7 MBPS is preferred.

At validate service availability 435 process block, service validation engine 420 requests for set of services 416 that are available based on a service order parameter. In an embodiment, the service order parameter may be an address of the customer requesting the service. Service validation engine 420 requests for set of services 416 that are available at the address of the customer. Set of services 416 obtained include first service 306, second service 307, third service 308, and fourth service 309.

At validate KPI and sales margin data 440 process block, service validation engine 420 validates KPI and sales margin data of each of the service from set of services 416. Service validation engine 420 determines from service validation rule set 417 that a minimum sales margin of “8%” is necessary as depicted by third business rule 313 in the table srvc_vldtn_rul_set 310. Service validation engine 420 determines that first service 306 has highest sales margin with value “9%”, second service 307 has lowest sales margin with value “6%” but has a kickback arrangement as indicated in the table set_of_srvcs 305. In an embodiment, the kickback arrangement may include a commission, an incentive, and a special discount. Third service 308 has a good sales margin with a value of “8%” and fourth service 309 has a second lowest sales margin with value “7%” as indicated in the table set_of_srvcs 305.

At validate up-selling capabilities and offers 445 process block, service validation engine 420 determines that first service 306 has great up-selling capabilities since first service 306 provides pay TV and mobile phone service as indicated in the table set_of_srvcs 305. Service validation engine 420 determines that second service 307 has offers such as “30% OFF” and product launch offers as indicated in the table set_of_srvcs 305. Service validation engine 420 determines that third service 308 has good up-selling capabilities since third service 308 provides pay TV service for soccer as indicated in the table set_of_srvcs 305. Service validation engine 420 determines that fourth service 309 has no up-selling capabilities and the only offer is providing a static IP address as indicated in the table set_of_srvcs 305. In an embodiment, service validation engine 420 may execute process block 425, process block 430, process block 435, process block 440 and process block 445 in any sequence.

Service validation engine 420 determines a set of services that may match service order 405 based on the above validations. At process block 450, service validation engine 420 generates service order proposals that match service order 405. The table srvc_ord_prop 315 depicts service order proposals generated by service validation engine 420. Service validation engine 420 assigns a rank to each of the service order proposals such as first service order proposal 316, second service order proposal 317, third service order proposal 318, and fourth service order proposal 319 as indicated in the table srvc_ord_prop 315. Fourth service order proposal 319 is assigned a lowest rank with value “4” since the sales margin is low and it has no up-selling capabilities compared to other service orders and thus, the fourth service order proposal 319 is removed from service order proposals. Third service order proposal 318 is assigned a second lowest rank with value “3” since it has good sales margin and good up-selling capabilities compared to fourth service 309 as indicated in the table set_of_srvcs 305 but not as good as first service 306 and second service 307. Second service order proposal 317 is assigned a rank with value “2” since it has highest sales margin and great up-selling capabilities as indicated in the table srvc_ord_prop 315. In first service order proposal 316, the kickback arrangement overrides the low margin as indicated in the table srvc_ord_prop 315 and also overrides the great up-selling capabilities and highest sales margin of first service 306. Thus, second service order 307 is assigned a highest rank with value “1” as indicated in the table srvc _ord_prop 315. Also, the speed of service which is 100 MBPS is the highest among all the service order proposals and the offers provided by second service 307 moves second service 307 above the rest.

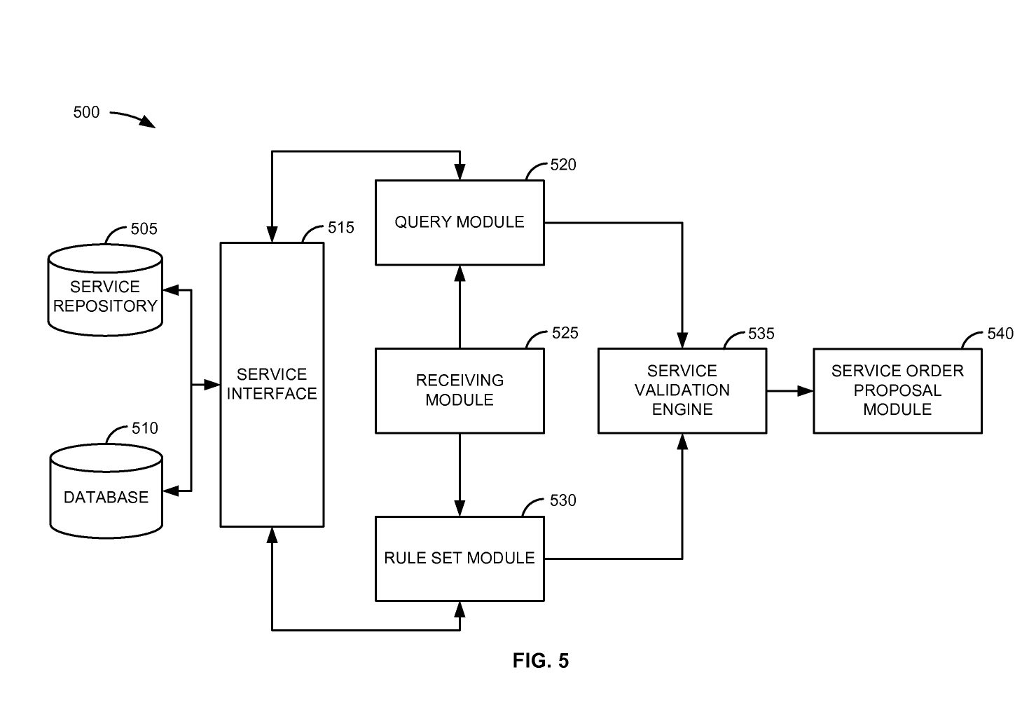

FIG. 5 is a block diagram of a system to validate a service order according to an embodiment of the invention. System 500 has receiving module 525 that receives a service order. A service type and service order parameters of the service order are captured. Service repository 505 contains a set of services that are provided by various service providers. Query module 520 fetches a set of services based on the service type and service order parameters. Query module 520 constructs a query that is used to fetch the set of services from the service repository. In an embodiment, query module 520 fetches the query from database 510. The set of services fetched from service repository 505 are typically services that may match the service order. In an embodiment, there may be a plurality of service repositories provided by various vendors. Service interface 515 provides application programming interface (API) to access service repository 505 and database 510 provided by various vendors. Rule set module 530 captures the service type of the service order received by receiving module 525 and fetches a service validation rule set from database 510. Service repository 505 and database 510 are accessed via service interface 515.

Service validation engine 535 evaluates the set of services with the service validation rule set to determine the set of services that match the service order. Service validation engine 535 evaluates the set of services with the service validation rule set to determine the set of services whose service parameters match the service order parameters of the service order. Service validation engine 535 passes a result of the evaluation to service order proposal module 540. Service order proposal module 540 generates service order proposals based on the result of evaluation. Service order proposal module 540 assigns a rank to each service order proposal that represents a degree of matching of the service order proposal with the service order.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
receiving a service order having a service order parameter and a service type;
determining a set of services based on the service order parameter and the service type;
fetching a service validation rule set based on the service type;
evaluating the set of services with the service validation rule set to generate an evaluation result; and
generating a service order proposal matching the service order based on the evaluation result.

2. The method in claim 1, wherein determining a set of services based on the service parameter and the service type comprises querying a service repository to obtain the set of services based on the service parameter and the service type.

3. The method in claim 1, wherein the service type comprises a service selected from a group consisting of a courier service, a telecom service, an entertainment service, internet service, a delivery service and a pickup service.

4. The method in claim 1, wherein the service order parameter comprises a service characteristic selected from a group consisting of cost of a service, deliver by date, deliver to address, a pickup by date, a pickup from address, speed of a broadband connection, and number of television channels.

5. The method in claim 1, wherein evaluating the set of services comprises:
determining if the set of services complies with business rules defined for a service in the service validation rule set; and
generating a service order proposal if the set of services does not comply with the business rules.

6. The method in claim 1, wherein generating a service order proposal comprises generating the service order proposal with a service parameter matching the service order parameter of the service order.

7. The method in claim 1, wherein generating a service order proposal comprises generating a rank of the service order proposal representing a degree of matching of the service order proposal with the service order.

8. A system, comprising:
a receiving module to receive a service order having a service order parameter and a service type;
a query module electronically coupled to the receiving module to determine a set of services based on the service order parameter and the service type;
a rule set module electronically coupled to the receiving module to fetch a service validation rule set based on the service type;
a service validation engine electronically coupled to the query module and the rule set module to evaluate the set of services with the service validation rule set to generate an evaluation result; and
a service order proposal module electronically coupled to the service validation engine to generate a service order proposal matching the service order based on the evaluation result.

9. The system in claim 8 further comprising a service repository to persist a service.

10. The system in claim 8 further comprising a service interface electronically coupled to the query module to fetch a service from a service repository.

11. The system in claim 8 further comprising a database electronically coupled to the rule set module via a service interface to persist the service validation rule set and a query.

12. An article of manufacture, comprising:
a machine readable medium having instructions which when executed by a machine cause the machine to:
receive a service order having a service order parameter and a service type;
determine a set of services based on the service order parameter and the service type;
fetch a service validation rule set based on the service type;
evaluate the set of services with the service validation rule set to generate an evaluation result; and
generate a service order proposal matching the service order based on the evaluation result.

13. The article of manufacture in claim 12, wherein the machine readable medium provides instructions, which when executed by a machine cause the machine to determine a set of services based on the service parameter and the service type comprises querying a service repository to obtain the set of services based on the service parameter and the service type.

14. The article of manufacture in claim 12, wherein the machine readable medium provides instructions, which when executed by a machine cause the machine to:
determine if the set of services comply with business rules defined for a service in the service validation rule set; and
generate a service order proposal if the set of services do not comply with the business rules.

15. The article of manufacture in claim 12, wherein the machine readable medium provides instructions, which when executed by a machine cause the machine to generate the service order proposal with a service parameter matching the service order parameter.
